(19) United States
(12) Patent Application Publication
(10) Pub. No.: US 2017/0250986 A1
(43) Pub. Date: Aug. 31, 2017

(54) SYSTEMS AND METHODS FOR CONTROLLING ACCESS TO POSITION INFORMATION

(71) Applicant: NextNav, LLC, Sunnyvale, CA (US)

(72) Inventors: VARAPRASAD VAJJHALA, San Ramon, CA (US); ARUN RAGHUPATHY, Bangalore (IN); DEEPAK JOSEPH, Oakton, VA (US)

(21) Appl. No.: 15/439,764

(22) Filed: Feb. 22, 2017

Related U.S. Application Data
(60) Provisional application No. 62/301,440, filed on Feb. 29, 2016.

(51) Int. Cl. H04L 29/06; H04W 12/06; G06F 1/32; H04W 4/02; H04W 12/08

(52) U.S. Cl. CPC H04L 63/10; H04W 4/02; H04W 12/08; H04L 63/0442; G06F 1/3234; H04L 63/08; H04W 12/06; G06F 2221/2103

(57) ABSTRACT

Controlling access to position information. Control of access to position information may be provided by exchanging authenticating messages that restrict distribution of the position information to authorized recipients. Alternatively, control of access may be provided by limiting when hardware that determines position information is active.

### RELATED APPLICATIONS

This application relates to the following related application(s): U.S. Pat. Appl. No. 62/301,440, filed 29 Feb. 2016, entitled SYSTEMS AND METHODS FOR CONTROLLING ACCESS TO POSITION INFORMATION. The content of each of the related application(s) is hereby incorporated by reference herein in its entirety.

### BACKGROUND

Determining the exact location of a receiver in an environment can be quite challenging, especially when the receiver resides in an urban environment, or is located within a building. Imprecise estimates of the receiver's position may have “life or death” consequences for the user. For example, an imprecise position estimate of a mobile phone operated by a user calling 911, can delay emergency personnel response times when responding to the call. In less dire situations, imprecise estimates of the user's position can negatively impact efforts to provide navigation to a desired destination.

Positioning systems for estimating the position of a receiver, like the widely-available Global Positioning System (GPS), have been in use for many years. Unfortunately, poor signal conditions found in urban and indoor environments may degrade the performance of these conventional positioning systems. To improve positioning accuracy in urban and indoor environments, estimates of a receiver's position can be determined using terrestrial positioning systems that transmit different positioning signals from different transmitters at different locations. If enabled to receive and process these terrestrial positioning signals, the receiver can determine position information like the times of arrival of individual positioning signals, the locations of the transmitters (e.g., in terms of latitude, longitude and/or altitude), and pressure and temperature at each transmitter, and use this position information to estimate its position (e.g., in terms of latitude, longitude and/or altitude, or other representation).

Since terrestrial positioning signals may or may not be made available in different parts of the world at different times and to different users, it is advantageous to manufacture all receivers with a capability to determine position information from terrestrial positioning signals. However, providing every receiver unfettered access to position information has its drawbacks. For instance, permitting a receiver to determine position information when that position information is not needed can decrease the battery life of that receiver. Also, entities that provide hardware, software or firmware for determining position information are unable to economically benefit from the use of the position information when access to the position information cannot be controlled.

Thus, there is a need to enable a wide distribution of receivers that are capable of determining position information using terrestrial positioning signals while controlling access the position information.

### BRIEF DESCRIPTION OF THE DRAWINGS

FIG. 1 depicts an operational environment for controlling access to position information.

FIG. 2 depicts features of a transmitter and a receiver that may operate in the operational environment of FIG. 1.

FIG. 3 illustrates a receiver's software stack used to determine and distribute position information.

FIG. 4 illustrates functional details of the receiver's software stack for controlling access to position information.

FIG. 5 illustrates functional details of authorizing a positioning engine SDK to communicate with a positioning engine.

FIG. 6 illustrates functional details of authorizing an application to communicate with a positioning engine SDK.

FIG. 7 illustrates functional details of authorizing a positioning engine to access positioning information from a position information measurement engine.

FIG. 8 illustrates functional details of authorizing a positioning engine to access positioning information from a position information measurement engine.

FIG. 9 illustrates functional details of requesting and receiving an estimated position of a receiver from a positioning engine.

FIG. 10A illustrates contents of an authorization request message.

FIG. 10B illustrates contents of an authorization response message.

FIG. 11A illustrates contents of a feature enable request message.

FIG. 11B illustrates contents of a feature enable response message.

FIG. 12 illustrates functional details of selectively indicating the presence of a position information module or the availability of position information based on the validity of an encrypted authorization request.

FIG. 13 illustrates functional details of exiting a position information module from a low power mode upon receiving an authorization request, and of returning the position information module to a low power mode if the authorization request is invalid.

### DETAILED DESCRIPTION

Various techniques are available to estimate the position of a receiver, including trilateration, which is the process of using geometry to estimate the position of a receiver using distances traveled by different “positioning” or “ranging” signals that are received by the receiver from different beacons—e.g., terrestrial transmitters and/or satellites—of the positioning system. Usually, the distance traveled by a positioning signal is determined using the signal's time-of-arrival (TOA), and different estimated distances (e.g., “pseudoranges”) corresponding to different positioning signals from different beacons can be used along with coordinates of those beacons to estimate the position of the receiver. Thus, if one desires to estimate the position of a receiver, it is critical that the positioning engine used to compute the receiver's estimated position has access to position information like the TOAs of the positioning signals, the locations of the beacons, and/or atmospheric information (e.g., pressure and temperature) at the locations of terrestrial beacons.

In some cases, however, controlling access to the position information is useful. For example, allowing unfettered access to the position information can reduce the performance of the receiver (e.g., reduce the receiver's battery life). Also, without the ability to control access to the position information, revenue-generating opportunities for commercial entities that develop technologies used to determine position information are diminished.

Various embodiments described herein control access to position information. In some embodiments, distribution of position information requires authorization—e.g., authorized distributions of position information are carried out using authentication messaging that is described in more detail below. Other embodiments enable or disable whether position information is determined—e.g., enabling and disabling whether position information is determined occurs by controlling the power state of a position information module that determines the position information.

Further details about each of the above approaches are provided below following a brief description of systems that are implicated by these approaches.

### Example Systems

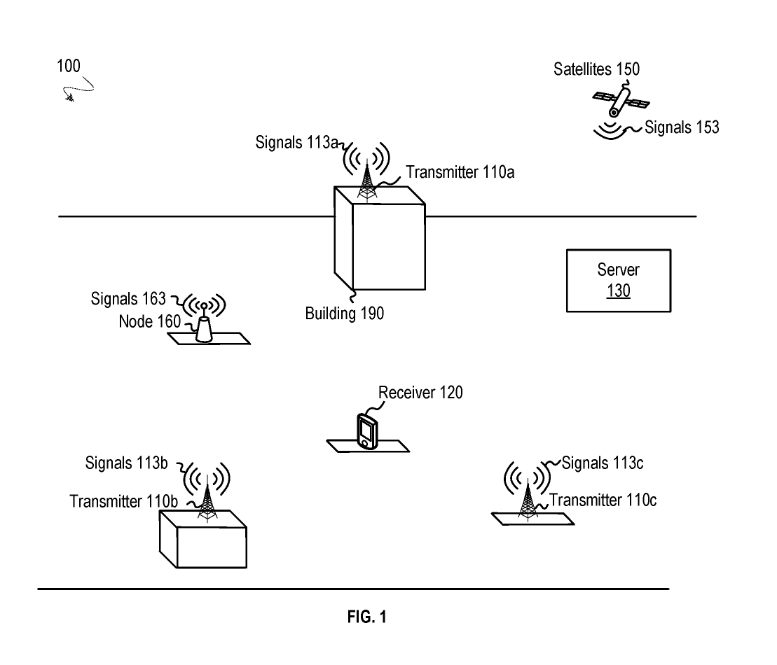

FIG. 1 illustrates an operational environment for controlling access to position information. The operational environment contains a positioning system 100 that includes any number of receivers 120. Signals 113, 153 and 163 are exchanged between the receivers 120 and transmitters 110, satellites 150, and/or other nodes 160, respectively, using known wireless or wired transmission technologies. The receivers 120 may also transmit signals among themselves and a server 130 (signals not shown). As shown, the receivers 120 can be at different altitudes or depths that are inside or outside various manmade or natural structures 190.

The server 130, which may include any number of processors, data sources, and other components, communicates with various other systems, such as the transmitters 110, the receivers 120, and the other networks 160.

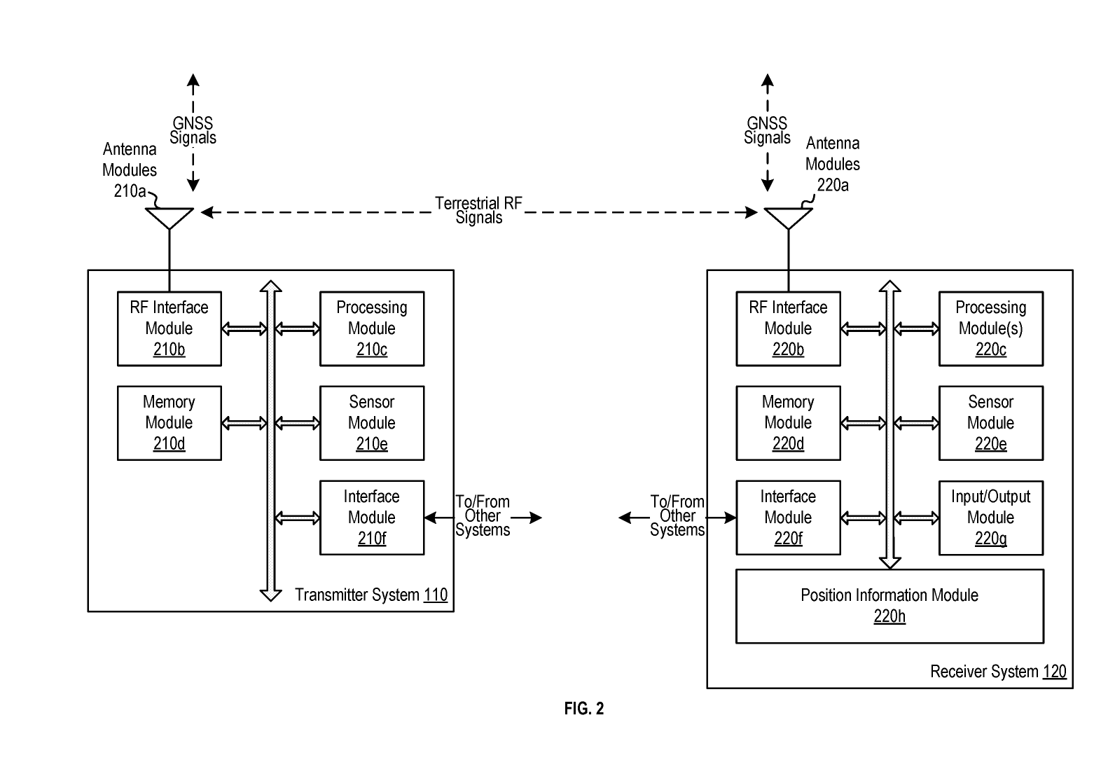

The transmitters 110 may transmit the signals 113 using one or more common multiplexing parameters—e.g. time slot, pseudorandom sequence, or frequency offset. Each of the signals 113 from each of the transmitters 110 carries different information that, once determined by the receiver 120 or the server 130, may identify any of the following: (1) the transmitter 110 that transmitted the signal; (2) the latitude, longitude and altitude (LLA) of that transmitter; (3) pressure, temperature, humidity, and other atmospheric conditions at or near that transmitter; and (4) other information. By way of example, as shown in FIG. 2, each of the transmitters 110 may include: one or more antenna modules 210a for receiving and transmitting signals from and to other systems; an RF interface module 210b that facilitates the exchange of information with other systems and includes various circuitry components (e.g., analog/digital logic and power circuitry, tuning circuitry, buffer and power amplifiers, and other components as is known in the art or otherwise disclosed herein); one of more processing modules 210c comprising one or more processors that perform signal processing (e.g., extracting information from received signals, and generating signals for transmission to other systems at a selected time, using a selected frequency, using a selected code, and/or using a selected phase) and other processing at a transmitter described herein; a memory module 210d that provides storage and retrieval of data and/or instructions relating to methods of operation described herein that may be executed by the one or more processing modules 210c; sensors modules 210e comprising sensors that measure environmental conditions at or near the transmitter; and a non-RF interface module 210f that exchanges information with other systems via other links other than a radio link.

Each of the receivers 120 in FIG. 1 may include one or more processing modules that: (1) demodulate received signals; (2) identify position information like estimated times of arrival or travel times of the received signals, locations of each transmitter, atmospheric information from each transmitter, and/or other information useful in estimating a receiver's position; and (3) use the position information to estimate the position of the receiver 120 (e.g., using processes for estimating the position like trilateration, or other approaches).

By way of example, as shown in FIG. 2, each of the receivers 120 may include: one or more antenna modules 220a for exchanging signals with other systems (e.g., satellites, terrestrial transmitters, receivers); an RF interface module 220b that facilitates the exchange of information with other systems, and that may include various circuitry components (e.g., mixers, filters, amplifiers, digital-to-analog and analog-to-digital converters as is known in the art or otherwise disclosed herein); one or more processing modules 220c that compute an estimated position of the receiver 120 and perform other processing described herein; a memory module 220d that provides storage and retrieval of data and/or instructions relating to methods of operation described herein that may be executed by the one or more processing modules 220c; sensor modules 220e comprising sensors that measure various information (e.g., pressure, temperature, humidity, wind, acceleration, velocity, orientation, light, sound, or other conditions); a non-RF interface module 220f that exchanges information with other systems via other links other than a radio link; an input/output module 220g comprising user I/O interfaces that permit a user to interact with the receiver 120; or a position information module 220h that determines position information which is used by the processing modules 220c to estimate a position of a receiver.

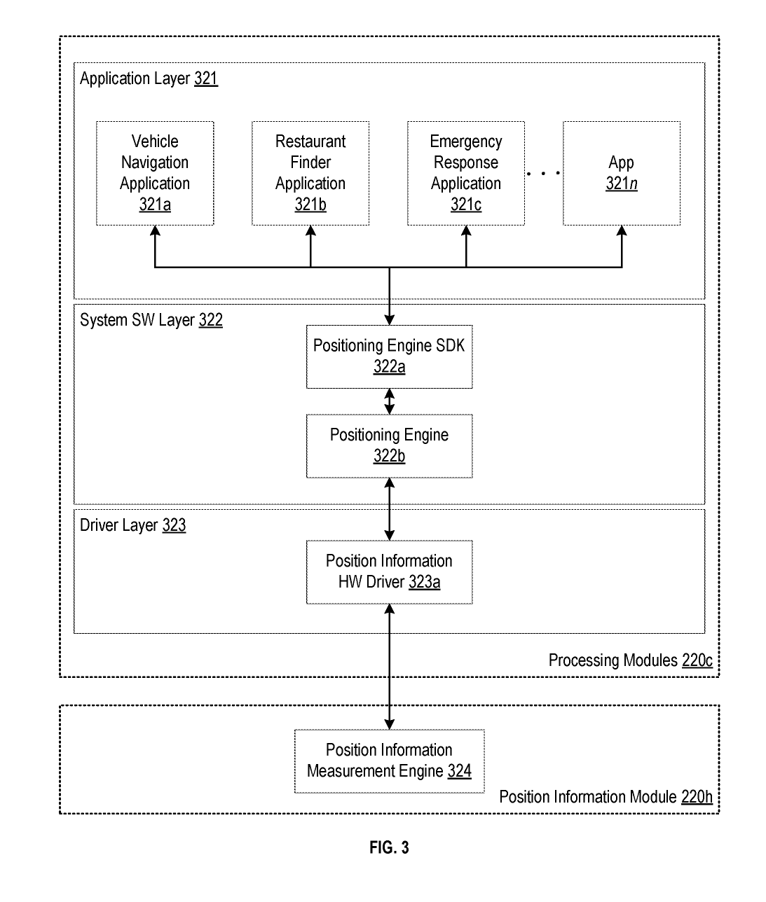

The processing module(s) 220c and the position information modules 220h may include one or more processors that may execute or “run” software or firmware. As shown in FIG. 3, the software or firmware may include a software or firmware “stack” (e.g., a hierarchy or collection of software and applications) that is used to determine and distribute position information. As shown, the software stack includes an application layer 321, a system software layer 322, and a driver layer 323 within the processing module(s) 220c, and a position information measurement engine 324 within the position information module 220h.

The application layer 321 includes applications which may require an estimated position (e.g., an estimated LLA) of the receiver 120 in order to provide a service to a user of the receiver 120. By way of example, applications may include a vehicle/pedestrian navigation application 321a, a restaurant finder application 321b, an application implementing emergency response system features (e.g., E911) 321c, or other applications 321n. As shown, applications of the application layer 321 can receive the estimated position from the system software layer 322.

The system software layer 322 includes a positioning engine software development kit (SDK) 322a and a positioning engine 322b. The positioning engine SDK 322a is an outward-facing software interface used to provide an estimated position or other data to authorized destinations (e.g., authorized applications of the application layer 321) while obscuring implementation details of the positioning engine 322b.

The positioning engine 322b computes an estimated position of the receiver 120 as is known in the art. In one embodiment, the positioning engine 322b generates the estimated position of the receiver 120 using position information received from the position information measurement engine 324 of the position information module 220h. If the positioning engine 322b is authorized to receive position information from the position information measurement engine 324, messages and data are exchanged using a position information module HW driver 323a of the driver layer 323, which serves to bridge communications between the position information measurement engine 322b and the position information measurement engine 324.

The position information measurement engine 324 of the position information module 220h, along with the position information HW Driver 323a, are responsible for controlling the hardware to receive signals from transmitter(s) 110 and/or satellite(s) 150. These modules understand the modulation and signaling protocols of the transmitted messages, and receive and demodulate the messages and information before they are passed to the positioning engine 322b. The position information measurement engine 324 is capable of producing a position information stream that includes position information such as coarse TOA's, locations of transmitters, and other information used by the positioning engine 322b to compute an estimated position of the receiver 120, as is known in the art.

Additional details about the functionality of the receiver's software stack, as well as the processing modules 220c and the position information module 220h, are provided below with respect to several functional process flows.

### Controlling Access to Position Information

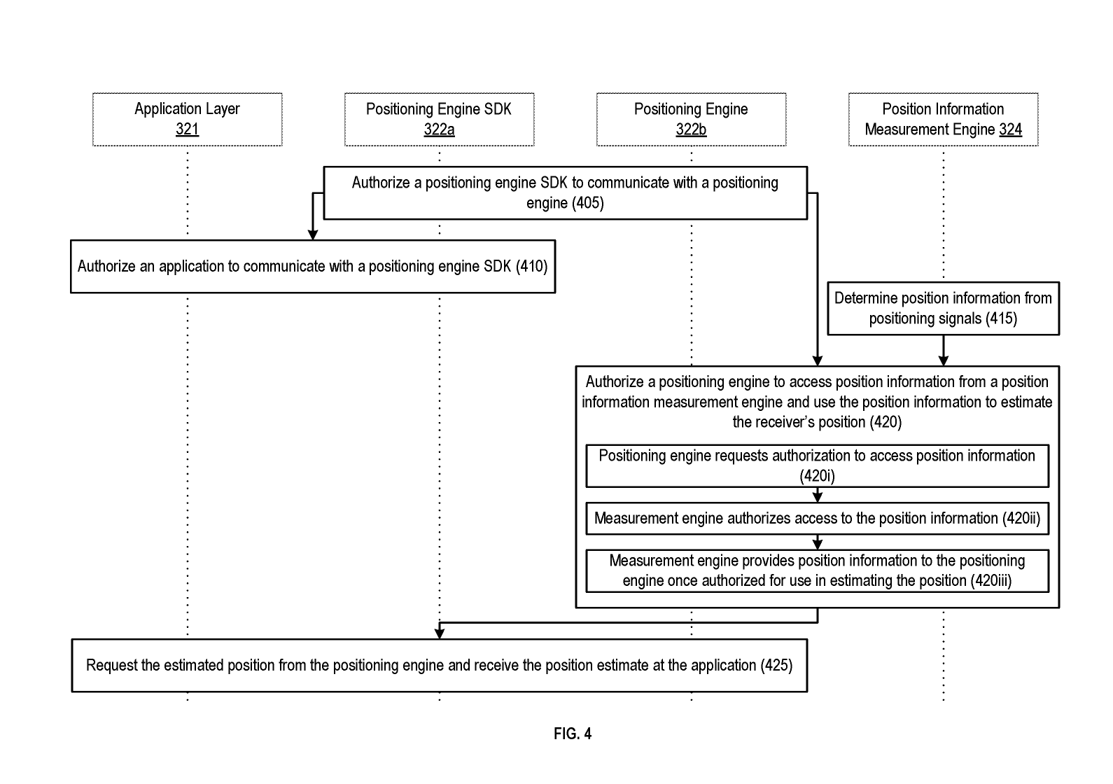

Attention is now drawn to FIG. 4, which illustrates functional details of the receiver's software stack for controlling access to position information.

As shown, the positioning engine SDK 322a is authorized to communicate with (e.g., receive an estimated position from) the positioning engine 322b at stage 405. An application of the application layer 321 is authorized to communicate with (e.g., receive an estimated position from) the positioning engine SDK 322a at stage 410. Although not shown, stage 410 could occur before stage 405.

The position information measurement engine 324 determines position information from positioning signals received from the transmitters 110 at stage 415. By way of example, the positioning information may include time-of-arrival measurements of the signals, LLA of each transmitter, and/or other information used in the art to estimate a receiver's position.

At stage 420, the positioning engine 322b is authorized to access the position information from the position information measurement engine 324, and the positioning engine 322b uses the position information to estimate the position of the receiver 120 using known techniques (e.g., trilateration). In one embodiment, the positioning engine 322b is authorized to access the position information from the position information measurement engine 324 as follows: the positioning engine 322b requests authorization to access position information at sub-stage 420(i); the measurement engine 324 authorizes access to the position information at sub-stage 420(ii); and the measurement engine 324 provides position information to the positioning engine 322b once authorized for use in estimating the position at sub-stage 420(iii).

At stage 425, the estimated position computed by the positioning engine 322b is provided to the authorized application.

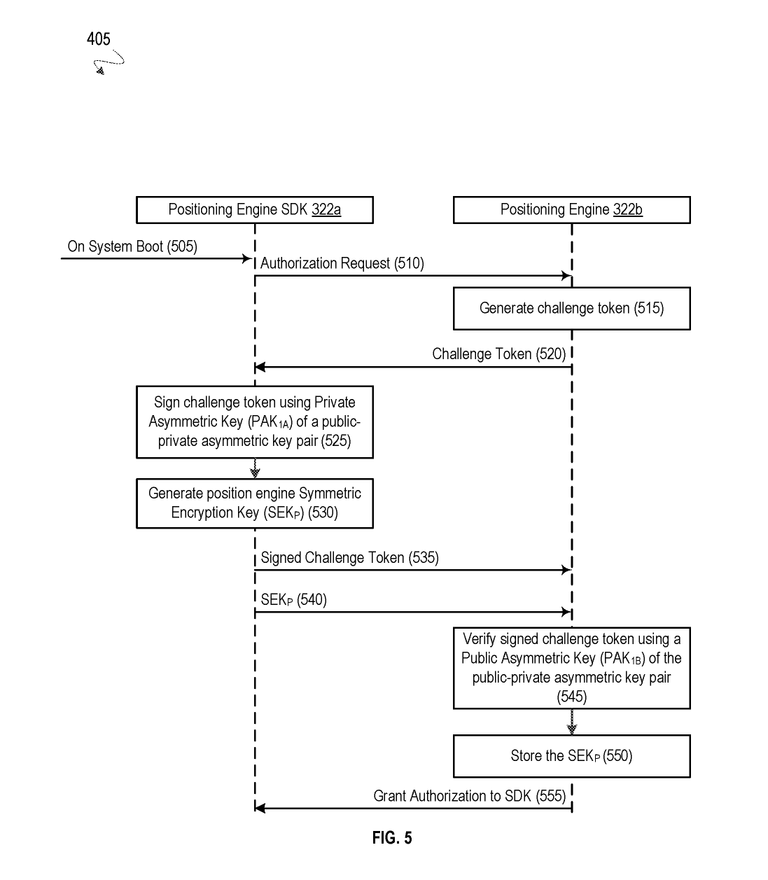

The stages of FIG. 4 can be carried out in different ways. By way of example, each of FIG. 5 through FIG. 9 depicts particular implementations of different stages from FIG. 4.

### Granting Authorization to a Positioning Engine SDK

A first set of authorization steps is shown in FIG. 5, which illustrates functional details of authorizing the positioning engine SDK 322a to communicate with the positioning engine 322b.

As shown at stage 505, authorization begins at a point within the system boot of the receiver 120. Of course, authorization could begin at another time (e.g., after an application from the application layer 321 requests an estimated position of the receiver 120 from the positioning engine SDK 322a). The positioning engine SDK 322a sends an authorization request to the positioning engine 322b at stage 510, after which the positioning engine 322b generates and sends a challenge token at stages 515 and 520. In one embodiment, the challenge token is implemented as a random number, but in another embodiment it is not a random number.

At stage 525, the positioning engine SDK 322a signs the challenge token using a private asymmetric key (“private key PAK_{1A}”) of a public-private asymmetric key pair, and then generates a symmetric encryption key (“session key SEK_{P}”) at stage 530. Next, at stages 535 and 540, the signed challenge token and the session key SEK_{P} are both transmitted to the positioning engine 322b. At stage 545, the positioning engine 322b verifies the signed challenge token using a public asymmetric key (“public key PAK_{1B}”) associated with the PAK_{1A} (e.g., of the public-private asymmetric key pair). Upon positively authenticating the signed challenge token, the positioning engine 322b stores the SEK_{P} at stage 550. The positioning engine 322b then transmits a grant of authorization to the positioning engine SDK 322a at stage 555. At this point, the positioning engine SDK 322a is authorized to communicate with the positioning engine 322b.

The SEK_{P} is a symmetric session key used by the positioning engine SDK 322a and the positioning engine 322b to encrypt/decrypt exchanged messages and data. In one embodiment the SEK_{P} conforms to a key used for an AES encryption algorithm known in the art.

Modules may store copies of corresponding symmetric session keys or store information used to derive the corresponding symmetric key. A “corresponding” symmetric session key is, for example, a key of a first module that will successfully decrypt a message that was encrypted with a key of a second module.

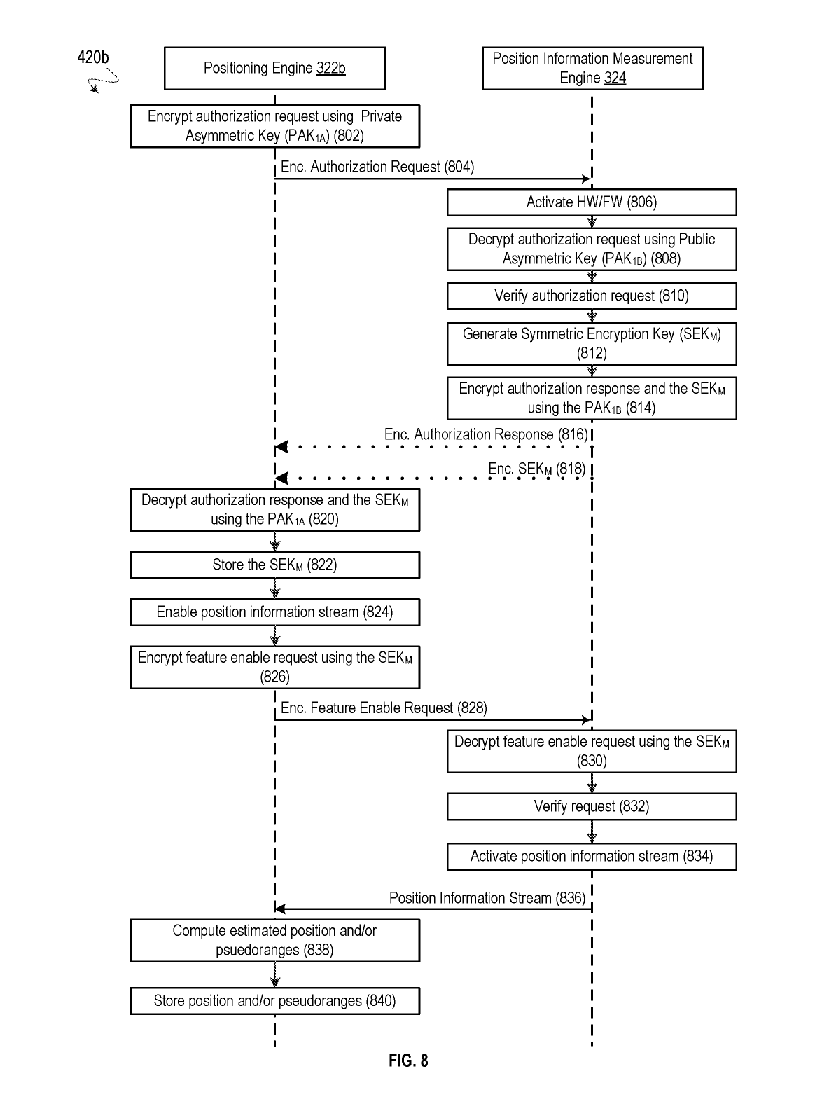

The PAK_{1A} is an asymmetric private key and the PAK_{1B}, is an asymmetric public key that may be used when authenticating communications between the positioning engine 322b and the position information measurement engine 324, as will be discussed at FIG. 8.

In one embodiment, the keys conform 1024-bit RSA encryption algorithms known in the art. Messages sent to the position information measurement engine 324 may be encrypted using the private key PAK_{1A} and decrypted at the measurement engine 324 using the public key PAK_{1B}. Messages and data sent from the position information measurement engine 324 may be encrypted using the public key PAK_{1B} and decrypted at the recipient using the private key PAK_{1A}.

In some implementations, the use of Public/Private key encryption (e.g., PAK_{1B}/PAK_{1A}) is used only for a limited set of requests. During the authorization process, a symmetric session key (e.g., SEK_{M}) is exchanged between the components and used for all subsequent encrypted communications. The encrypted authorization requests/responses may be 128 bytes, which is the output size of the RSA-1024 bit encryption engine with data padding as required.

When the private key PAK_{1A} is not stored at the receiver 120, the public asymmetric key PAK_{1B} may be delivered to the manufacturer of the receiver 120 via secure email or media to be incorporated into the receiver HW/FW during the final development/integration phase.

### Granting Authorization to an Application

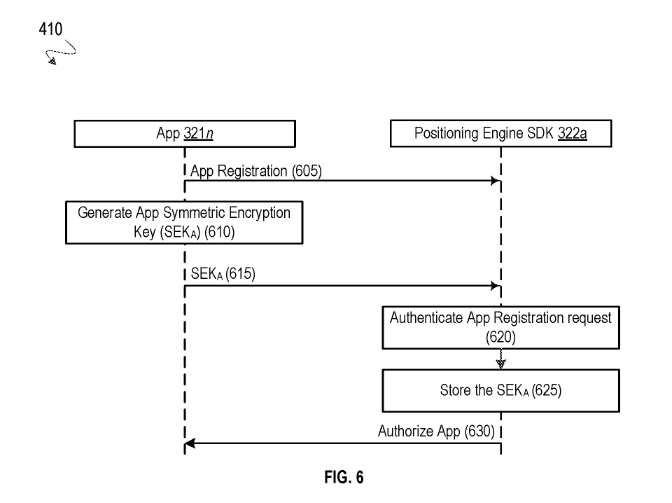

Another set of authorization steps is shown in FIG. 6, which illustrates functional details of authorizing the application 321n to communicate with the positioning engine SDK 322a.

The application 321n initiates a registration process by sending an app registration request to the positioning engine SDK 322a at stage 605. The application 321n then generates an application symmetric encryption key (“session key SEK_{A}”) at stage 610. The SEK_{A} is a symmetric session key used by the application 321n and the positioning engine SDK 322a to encrypt/decrypt exchanged messages and data. In one embodiment, the SEK_{A} conforms to a key used for AES encryption algorithms known in the art.

Next, at stage 615, the application 321n sends the SEK_{A} to the positioning engine SDK 322a. After the positioning engine SDK 322a receives the app registration request and the SEK_{A}, the positioning engine SDK 322a determines whether the app registration request is authentic at stage 620. Determination that the request is valid can be accomplished by several methods. The application may be on a “white list” of allowed applications, or the application may not be on a “black list” of prohibited or restricted applications. The application may be signed by an authorized entity. The engine could exchange a challenge/response with the application as is described above. The engine can request authorization for the application from an entity on the network such as the server 130. These methods, as well as other methods known in the art, can be used to authenticate an application.

If the app registration request is determined to be authentic, the positioning engine SDK 322a stores the session key SEK_{A} during stage 625. At stage 630, the positioning engine SDK 322a sends an authorize app signal to the application 321n informing the application 321n that the application is now authorized to communicate with the positioning engine SDK 322a.

### Granting Authorization to a Positioning Engine Using Un-Encrypted Messages

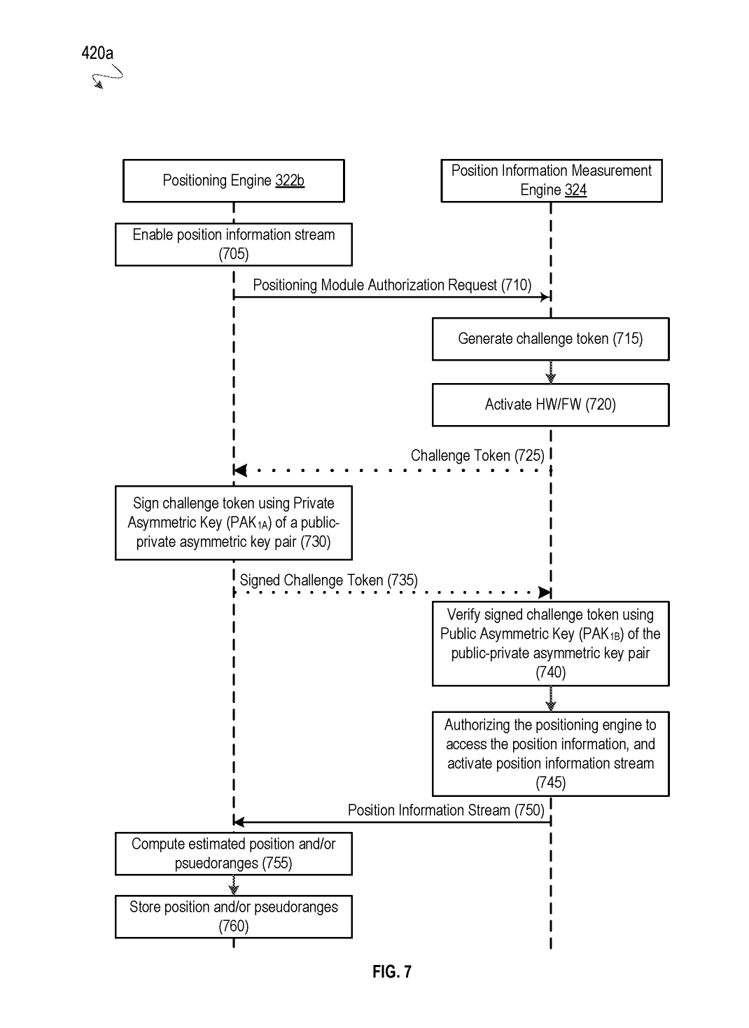

FIG. 7 illustrates functional details of authorizing the positioning engine 322b to access (e.g., exchange data/messages with) the position information measurement engine 324 of the position information module 220h.

The positioning engine 322b initiates the process of enabling a position information stream at stage 705, and transmits a position information module authorization request signal to the position information measurement engine 324 at stage 710. Having received the request, the position information measurement engine 324 generates a challenge token and activates position information measurement engine firmware at stages 715 and 720.

The position information measurement engine 324 may then conditionally transmit the challenge token to the positioning engine 322b at stage 725. Conditional transmission is discussed in more detail with respect to FIG. 8. At stage 730, the positioning engine 322b signs the challenge token with the private key PAK_{1A}. The signed challenge token is then transmitted to the position information measurement engine 324 at stage 735, and is verified using the public key PAK_{1B} at stage 740.

If the challenge token is positively verified (e.g., authenticated), the positioning engine 322b is authorized to access the position information, and the position information measurement engine 324 activates a position information stream at stage 745. The position information stream is received by the positioning engine 322b at stage 750.

At stage 755, the positioning engine 322b may use position information identified within the position information stream to generate an estimated position of the receiver 120. At stage 760, an estimated position of the receiver 120 as well as other data, such as pseudoranges used to estimate the position, are stored for later use.

As was shown in FIG. 3, messages transmitted between the positioning engine 322b and the position information measurement engine 324 can be exchanged via the position information module HW driver 323a.

### Granting Authorization to a Positioning Engine Using Encrypted Messages

FIG. 8 illustrates functional details of authorizing the positioning engine 322b to access the position information measurement engine 324 using encrypted messages.

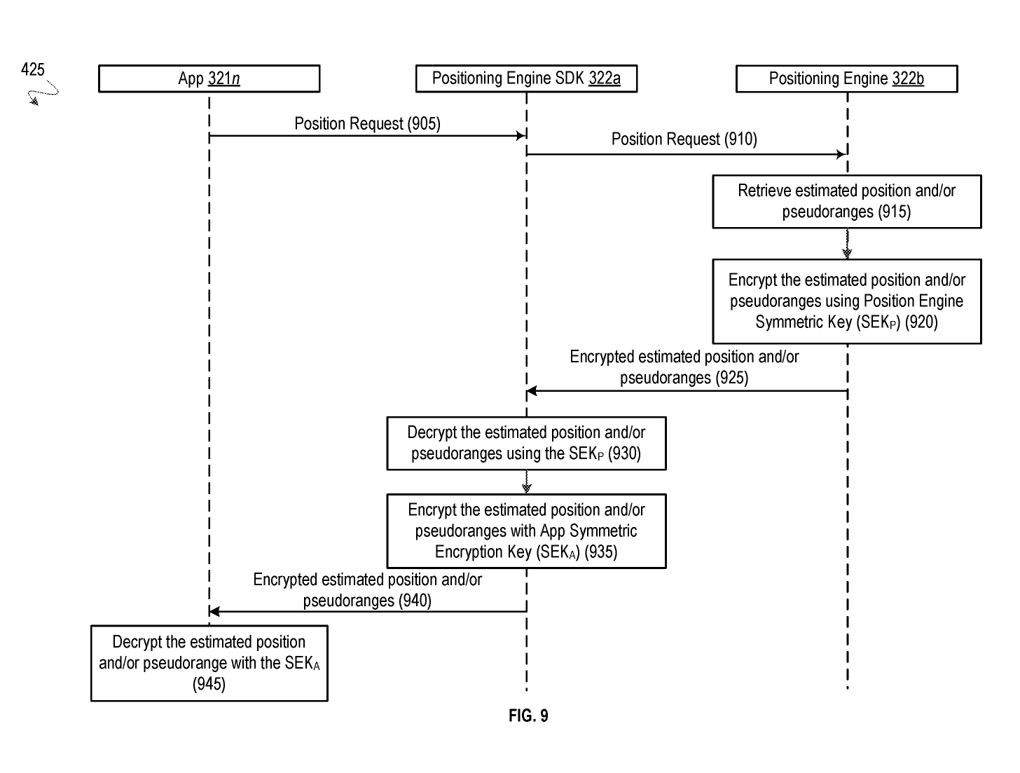

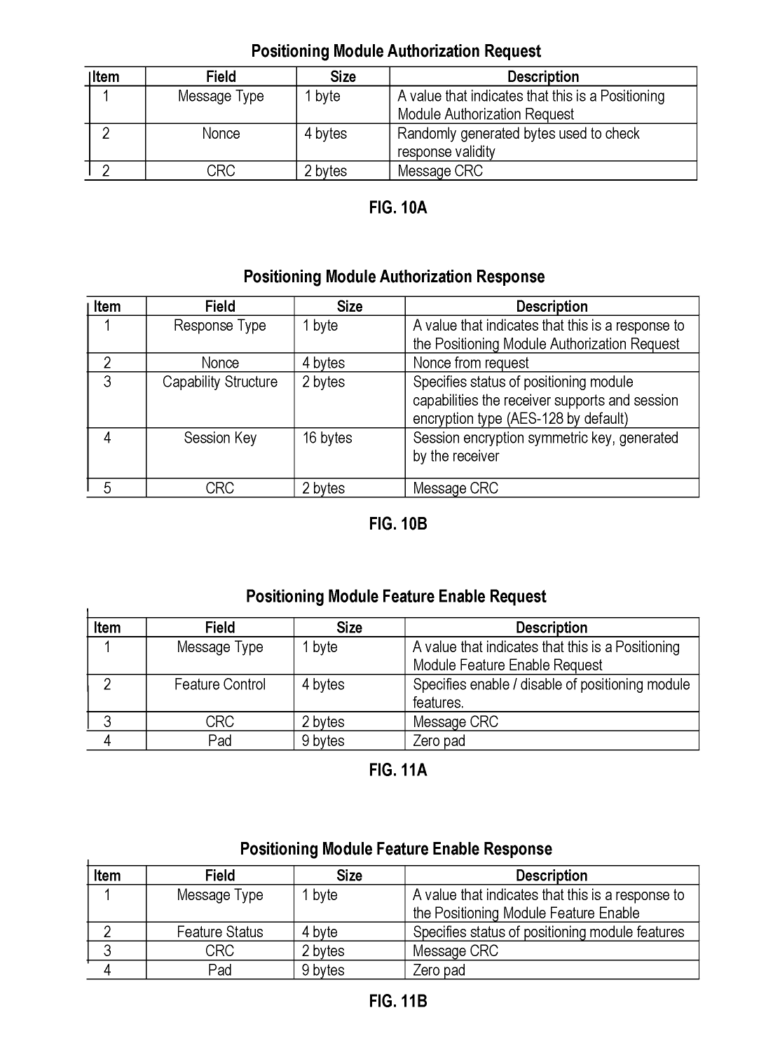

As shown at stage 802, the positioning engine 322b encrypts a position information module authorization request using the private key PAK_{1A}. The encrypted position information module authorization request is then transmitted, at stage 804, to the position information measurement engine 324. Details of the position information module authorization request 804 message contents are shown in FIG. 10A.

At stage 806, the position information measurement engine 324 activates the position information measurement engine 324 (e.g., exits the position information module 220h from a power-saving state, performs initialization routines, and other activities). At stage 808, the position information measurement engine 324 decrypts the encrypted position information module authorization request using the public key PAK_{1B}, and verifies the authenticity of the request at stage 810.

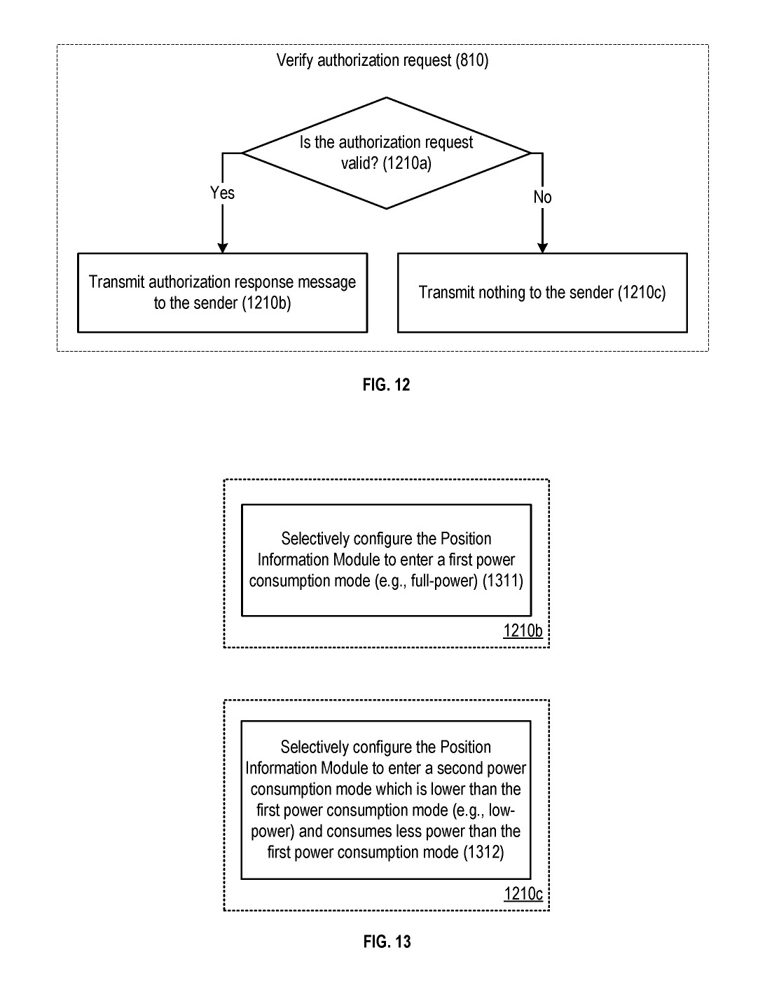

If the authenticity of the position information module authorization request is positively verified at stage 810, the position information measurement engine 324 generates a position information module symmetric session key (“session key SEK_{M}”) at stage 812. The session key SEK_{M} may be used in lieu of potentially more computationally expensive cryptography processes associated with asymmetric Private/Public key encryption algorithms (e.g., PAK_{1A} and PAK_{1B}). In one embodiment, if the verification step at stage 810 does not positively authenticate the position information module authorization request, the position information measurement engine 324 will not transmit the position information module authorization response or session key SEK_{M}, as indicated through the use of dashed lines associated with these messages. Details of this embodiment are discussed with respect to FIG. 12. Additionally, in another embodiment, if the verification step at stage 810 does not positively authenticate the position information module authorization request, the position information module 220h may enter a low-power state. Details of this embodiment are discussed with respect to FIG. 13.

At stage 814, the position information measurement engine 324 uses the public key PAK_{1B} to encrypt both a position information module authorization response and the generated session key SEK_{M}. At stages 816 and 818, the position information measurement engine 324 transmits the encrypted position information module authorization response and the encrypted session key SEK_{M} to the positioning engine 322b. Details of the position information module authorization response 816 message contents are shown in FIG. 10B.

At stage 820, the positioning engine 322b decrypts the encrypted position information module authorization response and the encrypted session key SEK_{M} using the private key PAK_{1A}. At stage 822, the positioning engine 322b stores the decrypted session key SEK_{M} for use during future message/data stream exchanges with the position information measurement engine 324. At stage 824, the positioning engine 322b determines whether to enable a feature of the position information measurement engine 324 (e.g., a data stream of position information, single or multiple time-of-arrival estimates, and other information). At stage 826, the positioning engine 322b encrypts a position information module feature enable request using the session key SEK_{M} and transmits the encrypted request to the position information measurement engine 324 at stage 828. Details of the position information module feature enable request message contents are shown in FIG. 11A.

The position information measurement engine 324 receives the encrypted position information module feature enable request, and at stage 830, decrypts the encrypted position information module feature enable request using the session key SEK_{M}. The position information measurement engine 324 then verifies the feature enable request at stage 832, and after positive verification, activates and transmits a position information stream at stages 834 and 836. In one embodiment, a position information module enable response message is transmitted to the positioning engine 322b from the position information measurement engine 324. Contents of this message are shown in FIG. 11B.

At stage 838, the positioning engine 322b uses position information identified within the position information stream to generate an estimated position of the receiver 120. At stage 840, an estimated position of the receiver 120, as well as other data such as the pseudoranges, are stored for later use.

### Requesting and Receiving Position Information

An application 321n may request and receive an estimated position and other information from the positioning engine 322b via the positioning engine SDK 322a. Functional details of requesting and receiving an estimated position of a receiver from the positioning engine 322b are shown in FIG. 9.

At stage 905, the application 321n requests position information by transmitting a position request to the positioning engine SDK 322a. The positioning engine SDK 322a then requests position information from the positioning engine 322b by transmitting a position request at stage 910. At stage 915, the positioning engine 322b identifies a stored estimated position and/or pseudorange values. Alternatively, at stage 915 the positioning engine 322b generates an estimated position and/or pseudorange values. At stage 920, the positioning engine 322b encrypts the estimated position and/or pseudorange values using the session key SEK_{P}. The encrypted estimated position and/or pseudorange values are then transmitted to the positioning engine SDK 322a at stage 925. At stage 930, the positioning engine SDK 322a uses the session key SEK_{P} to decrypt the encrypted estimated position and/or pseudorange values. At stage 935, the positioning engine SDK 322a re-encrypts the estimated position and/or pseudorange values using the application session key SEK_{A}. At stage 940, the positioning engine SDK 322a transmits encrypted estimated position and/or pseudorange values to the application 321n. The application 321n decrypts the encrypted estimated position and/or pseudorange values using its copy of the session key SEK_{A} at stage 945.

### Message Content Details

Details of embodiments of the contents of messages exchanged between the positioning engine 322b and the position information measurement engine 324 are shown in FIG. 10A, FIG. 10B, FIG. 11A and FIG. 11B.

FIG. 10A illustrates the contents of a position information module authorization request message, which corresponds to the message of stage 710 and the encrypted message of stage 804. FIG. 10B illustrates the contents of a position information module authorization response message, which corresponds to the encrypted message of stage 816. FIG. 11A illustrates the contents of a position information module feature enable request message, which corresponds to the message of stage 828. FIG. 11B illustrates the contents of a position information module feature enable response message.

In one embodiment, both the encoded position information module feature enable request message and the position information module feature enable response message are encrypted using the receiver generated session key SEK_{M} and are zero padded to match the cipher block length.

### Conditional Response to Authorization Attempts

As was discussed in relation to FIG. 8, if the verification operation (stage 810) conducted at the position information measurement engine 324 does not result in positively authenticating the requestor, the position information measurement engine 324 will not transmit a response. FIG. 12 illustrates functional details of selectively exposing the presence of (e.g., sending responses from) the position information module 220h based on the validity of an encrypted authorization request. The steps of the process include: determining if the authorization request is valid (step 1210a); transmitting, if the authorization request is valid, an authorization response message to the sender (step 1210b); and transmitting, if the authorization request is not valid, nothing to the sender (step 1210c).

### Conditional Power State Selection in Response to Authorization Attempts

In addition to only transmitting a response from the position information measurement engine 324 if it has received a valid authorization request, the position information module 220h may enter a low-power mode (e.g., sleep mode) if the authorization request was not valid. As was discussed in relation to FIG. 8, if the verification operation (stage 810) conducted at the position information measurement engine 324 does not result in positively authenticating the requestor, the position information module 220h may enter a low-power state. FIG. 13 illustrates functional details of exiting the position information module 324 from a low-power mode upon receiving an authorization request and returning to a low-power mode if the authorization request is invalid. If it is determined that the authorization request is valid, the receiver system 120 may selectively configure the position information module 220h to enter a first power consumption mode (step 1311). That is, if authorization is successful, the position information module 220h may leave a low-power mode (e.g., sleep mode) and enter a higher-power mode (e.g., active mode). If, on the other hand, the authorization request is determined to not be valid, the receiver system 120 may selectively configure the position information module 220h to enter a second power consumption mode in which the power consumption of the position information module 220h is lower than the first power consumption mode (step 1312). That is, the position information module 220h may enter a low-power mode to conserve system power if the module will not be used.

### Particular Embodiments

Methods of this disclosure may be implemented by hardware, firmware or software. One or more non-transitory machine-readable media embodying program instructions that, when executed by one or more machines, cause the one or more machines to perform or implement operations comprising the steps of any of the described methods are also contemplated. As used herein, machine-readable media includes all forms of statutory machine-readable media (e.g. statutory non-volatile or volatile storage media, statutory removable or non-removable media, statutory integrated circuit media, statutory magnetic storage media, statutory optical storage media, or any other statutory storage media). As used herein, machine-readable media does not include non-statutory media. By way of example, machines may include one or more computing device(s), processor(s), controller(s), integrated circuit(s), chip(s), system(s) on a chip, server(s), programmable logic device(s), other circuitry, and/or other suitable means described herein or otherwise known in the art.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps performed by a transmitter or a receiver can be performed by a server, or vice versa.

Systems comprising one or more modules that perform, are operable to perform, or adapted to perform different method steps/stages disclosed herein are also contemplated, where the modules are implemented using one or more machines listed herein or other suitable hardware. In one embodiment, a system comprises: a position information measurement engine module and a positioning engine module, wherein the position information measurement engine module is operable to receive a request for authorizing the positioning engine module to access position information, authorize the positioning engine module to access the position information, provide the position information to the positioning engine module after authorizing the position engine module to access the position information, and wherein the positioning engine module is operable to estimate the receiver's position using the position information, and to provide the estimated position to a software application module.

When two things (e.g., modules or other features) are “coupled to” each other, those two things may be directly connected together (e.g., shown by a line connecting the two things in the drawings), or separated by one or more intervening things. Where no lines and intervening things connect two particular things, coupling of those things is contemplated unless otherwise stated. Where an output of one thing and an input of another thing are coupled to each other, information (e.g., data and/or signaling) sent from the output is received by the input even if the data passes through one or more intermediate things. All information disclosed herein may be transmitted over any communication pathway using any protocol. Data, instructions, commands, information, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

It is noted that the term “positioning system” may refer to satellite systems (e.g., Global Navigation Satellite Systems (GNSS) like GPS, GLONASS, Galileo, and Compass/Beidou), terrestrial systems, and hybrid satellite/terrestrial systems. Additional embodiments are contemplated where satellite positioning signals are used instead of terrestrial positioning signals, and access to position information determined from the satellite positioning signals is conditionally controlled.

1. A method for controlling access to position information at a receiver, the method comprising:
receiving a request for authorizing a positioning engine to access position information;
authorizing the positioning engine to access the position information;
providing the position information to the positioning engine after authorizing the position engine to access the position information;
estimating, at the positioning engine, the receiver's position using the position information; and
providing the estimated position to a software application.

2. The method of claim 1, the method comprising:
authorizing a positioning engine software development kit (SDK) to communicate with the positioning engine.

3. The method of claim 2, the method comprising:
authorizing the software application to communicate with the positioning engine SDK.

4. The method of claim 2, wherein the authorizing the positioning engine SDK to communicate with the positioning engine comprises:
receiving, at the positioning engine, an authorization request;
providing, from the positioning engine, an unsigned challenge token;
receiving, at the positioning engine, a signed challenge token;
verifying, at the positioning engine, the signed challenge token; and
providing, from the positioning engine, authorization for the positioning engine SDK to communicate with the positioning engine.

5. The method of claim 4, wherein the unsigned challenge token is signed at the positioning engine SDK using a private asymmetric encryption key of a public-private asymmetric key pair, and wherein the signed challenge token is verified at the positioning engine using a public asymmetric encryption key of the public-private asymmetric key pair.

6. The method of claim 3, wherein the authorizing the software application to communicate with the positioning engine SDK comprises:
receiving, at the positioning engine SDK, a registration request;
authenticating, at the positioning engine SDK, the registration request; and
providing, from the positioning engine SDK, authorization for the software application to communicate with the positioning engine SDK.

7. The method of claim 1, wherein the authorizing the positioning engine to access the position information comprises:
providing, from the position information measurement engine, an unsigned challenge token;
receiving, at the position information measurement engine, a signed challenge token;
verifying the signed challenge token; and
upon verification of the signed challenge token, authorizing the positioning engine to access the position information from the position information measurement engine.

8. The method of claim 7, wherein the unsigned challenge token is signed at the positioning engine using a private asymmetric encryption key of a public-private asymmetric key pair, and wherein the signed challenge token is verified at the position information measurement engine using a public asymmetric encryption key of the public-private asymmetric key pair.

9. The method of claim 1, wherein the authorizing the positioning engine to access the position information comprises:
determining if the request is valid;
if the request is determined to be valid, transmitting a response message; and
if the request is determined to be invalid, not transmitting a response message,
wherein the response message is encrypted at the position information measurement engine, and the encrypted response message is decrypted at the positioning engine.

10. The method of claim 1, wherein the authorizing the positioning engine to access the position information comprises:
determining if the request is valid;
if the request is determined to be valid, entering a first power consumption mode; and
if the request is determined to be invalid, entering a second power consumption mode that consumes less power than the first power consumption mode.

11. The method of claim 1, wherein the authorizing the positioning engine to access the position information comprises:
determining if the request is valid,
wherein the request is encrypted at the positioning engine, and the encrypted request is decrypted at the position information measurement engine

12. The method of claim 1, wherein the providing the estimated position to a software application comprises:
receiving, at the positioning engine, a message from a positioning engine SDK requesting the estimated position; and
providing the estimated position from the positioning engine to the positioning engine SDK.

13. The method of claim 12, wherein the providing the estimated position to a software application comprises:
encrypting the estimated position prior to providing the estimate position to the positioning engine SDK; and
decrypting the encrypted estimated position at the positioning engine SDK.

14. The method of claim 13, wherein the providing the estimated position to a software application comprises:
receiving, at the positioning engine SDK, a message from the software application requesting the estimated position;
encrypting the estimated position at the positioning engine SDK;
providing the encrypted estimated position from the positioning engine SDK to the software application; and
decrypting the encrypted estimated position at the software application.

15. The method of claim 1, wherein the position information comprises one or more of latitude and longitude of a transmitter, an altitude of the transmitter, or a pseudorange.

16. The method of claim 1, wherein the estimated position comprises one or more of latitude and longitude, or an altitude.

17. One or more non-transitory machine-readable media embodying program instructions that, when executed by one or more machines, cause the one or more machines to implement the method of claim 1.

18. A system for controlling access to position information at a receiver, the system comprising:
a position information measurement engine module and a positioning engine module,
wherein the position information measurement engine module is operable to receive a request for authorizing the positioning engine module to access position information, authorize the positioning engine module to access the position information, provide the position information to the positioning engine module after authorizing the position engine module to access the position information, and
wherein the positioning engine module is operable to estimate the receiver's position using the position information, and to provide the estimated position to a software application module.
